(19) United States
(12) Patent Application Publication
(10) Pub. No.: US 2026/0165533 A1
(43) Pub. Date: Jun. 18, 2026

(54) System and method for grinding coffee beans and kit for a coffee grinder

(71) Applicant: Cimbali Group S.p.A., Binasco MI (IT)

(72) Inventor: Giacomo ABBIATI, Binasco MI (IT)

(21) Appl. No.: 19/422,558

(22) Filed: Dec. 17, 2025

(30) Foreign Application Priority Data
Dec. 18, 2024 (IT) 102024000028830

(51) Int. Cl. A47J 42/36; A47J 42/40; A47J 42/50; B02C 23/30

(52) U.S. Cl. CPC A47J 42/36; A47J 42/40; A47J 42/50; B02C 23/30

(57) ABSTRACT

System for grinding coffee beans, which comprises:
a coffee grinder provided with: a grinding chamber; grinding members, arranged in the grinding chamber, configured to grind coffee beans and obtain ground coffee; a supply duct having a supply opening and configured to convey coffee beans from the supply opening to the grinding chamber;
a container having: a cavity adapted to contain a dose of coffee beans, and a loading and unloading opening placed in communication with the cavity;
coupling members configured to removably couple the container to the supply duct of the coffee grinder so that, when coupled, the cavity of the container is in fluid communication with the grinding chamber of the coffee grinder;
wherein the container comprises pumping members made of elastomeric material which, by elastically deforming, allow an air flow to be generated, directed from the cavity of the container and to the grinding chamber when the container is coupled to the supply duct by means of the coupling members.

### DESCRIPTION

### Technical Field

The present invention relates to a system and a method for grinding coffee beans which find useful application in the preparation of coffee-flavoured beverages and, in particular, in gourmet coffee shops.

The present invention also relates to a kit for a coffee grinder employable for grinding coffee beans both in public businesses—such as, for example, bars and restaurants—and in domestic environments.

### Background Art

In gourmet coffee shops, coffee is often present as single-origin and just as often it is present as unroasted single-origin. It is however possible to find in these establishments high-quality blends, typically artfully created by the operators themselves, starting from selected single-origins.

In this type of establishment, the preparation of a cup of coffee follows a sui generis ceremony in which the barista plays a leading role. The preparation process begins by taking a dose of coffee beans and, if necessary, roasting it by using an artisanal roaster. The coffee beans, roasted or not as the case may be, are then placed by the barista into a coffee grinder, in particular of the type commonly called “single shot”, and the ground coffee thus obtained is subsequently converted into a beverage by infusing it with hot water. The infusion procedure can be conducted either by gravity, as happens for example in filter coffee (in English, “drip coffee”) using so-called drippers, or under pressure, as is the case in espresso coffee obtained by using coffee machines.

The quality and organoleptic properties of the coffee-flavoured beverage thus obtained are strictly correlated to the skill and experience of the barista who must not only know how to roast the coffee, but must also know how to operate the equipment for the preparation of coffee-flavoured beverages with skillful diligence.

The barista must therefore be able to have equipment that allows him to exploit his creative potential to the fullest. It is particularly worth noting that coffee grinders play an essential role in gourmet coffee shops. For this reason, coffee grinders/grinders called “single shot” have been introduced on the market, designed to be very versatile, precise and without a hopper, i.e. that coffee bean collector which equips traditional grinders.

The absence of the hopper is one of the fundamental characteristics of single shot grinders as it prevents the coffee beans from remaining exposed to the air for a long time, becoming rancid and losing part of their aromas. Instead of the hopper, single shot grinders have a simple cylindrical intake duct, having an open end adapted to receive the coffee beans to be ground and an opposite end connected to a grinding chamber in which grinding members are housed.

In use, the barista pours a predetermined dose of coffee beans into the open end of the duct which, passing through it to the opposite end, thus reaches the grinding chamber where it is transformed into ground coffee. It should be specified that the predetermined dose of coffee beans fed by the barista into the single shot coffee grinder is such as to exclusively satisfy the consumer's order (espresso, americano, etc.). Therefore, in this way, the problem of rancidity typical of traditional grinders in which the coffee beans are stored for long times in the hopper before their grinding and use is avoided.

Even with these precautions, there are still some problems that interfere with the quality of the served coffee-flavoured beverage. It is noted, in fact, that traces of the dose of coffee introduced into the grinder still remain inside the grinding chamber at the end of the grinding process. Such traces must be able to be eliminated to avoid, on the one hand, its rapid rancidity and, on the other hand, the contamination of the ground coffee obtained from subsequent grindings which could have different granulometries, roasts, or come from different single-origins.

For this purpose, over the years, coffee grinders have been developed that are capable of generating an aeriform flow in the grinding chamber suitable for removing the traces of ground coffee sedimented therein. Examples of such coffee grinders are described in European publications EP4044883B1 and EP3282906B1.

In detail, document EP4044883B1 describes a coffee grinder in which the elimination of coffee residues in the grinding chamber occurs by using a pressurized gas contained in a tank, while document EP3282906B1 describes a coffee grinder comprising a pneumatic member configured to generate a flow of pressurized air in the grinding chamber.

Although such solutions are able to clean the grinding chamber of coffee powder residues, they are not, however, free from drawbacks as, by requiring the introduction of special fluid-dynamic members (e.g. ducts, pumping members, tanks, valves), they considerably complicate the architecture of the coffee grinders and increase their costs. It is also evident that the solutions proposed by the state of the art are not implementable, at least not quickly and easily, in coffee grinders already on the market.

### Object of the Invention

In this context, the technical task underlying the present invention is to propose a system for grinding coffee beans that overcomes the drawbacks of the prior art mentioned above.

In particular, an object of the present invention is to provide a system for grinding coffee beans that has a simple construction and is capable of guaranteeing a high quality of the ground coffee.

It is also an object of the present invention to provide a simple method for grinding coffee beans capable of guaranteeing the obtainment of high-quality ground coffee.

It is a further object of the present invention to provide a kit capable of increasing the quality of the ground coffee with the coffee grinders present on the market.

### SUMMARY OF THE INVENTION

In accordance with the present invention, the indicated technical task and the specified objects are achieved by a system and a method for grinding coffee beans as well as by a kit for a coffee grinder according to one or more of the claims appended below.

In particular, the present invention proposes to provide a system for grinding coffee beans which comprises a container provided with pumping members made of elastomeric material which, by elastically deforming, allow an air flow to be generated, suitable for cleaning the grinding chamber of the residues of ground coffee accumulated therein.

The system object of the present invention also comprises coupling members configured to removably couple the container to a supply duct of the coffee grinder which is placed in communication with its grinding chamber.

In use, to clean the grinding chamber of coffee residues, it will be sufficient for the barista to act on the container while it is coupled to the supply duct of the coffee grinder by means of the coupling members. The elastic deformation of the pumping members will in fact generate an air flow in the supply duct directed from the cavity of the container to the grinding chamber. The pumping members and the coupling members therefore allow the container to be exploited not only to collect and transport the dose of coffee beans to be ground, but also to generate the air flow for cleaning the grinding chamber.

The technical solution object of the present invention is of simple construction as it does not require the creation of additional fluid-dynamic systems for cleaning the grinding chamber.

The present invention also relates to a simple method for grinding coffee beans that allows the grinding chamber of the coffee grinder to be kept clean by simply acting on the container downstream of each grinding process.

The present invention also allows providing a kit comprising the aforementioned container and coupling members which, not requiring structural modifications to the coffee grinder, are easily and quickly employable even with coffee grinders already on the market to improve the quality of the ground products.

### BRIEF DESCRIPTION OF THE DRAWINGS

Further characteristics and advantages of the present invention will appear more clearly from the indicative, and therefore non-limiting, description of a preferred but not exclusive embodiment of a system for grinding coffee beans, as illustrated in the accompanying drawings in which:

FIG. 1 shows a side sectional view of a first embodiment of a system for grinding coffee beans according to the present invention,

FIG. 2 shows an enlargement of a detail of FIG. 1,

FIG. 3 shows a perspective view of a component of the system for grinding coffee beans of FIG. 1,

FIG. 4a shows a perspective view of a first part of the component of FIG. 3,

FIG. 4b shows a perspective view of a second part of the component of FIG. 3,

FIG. 5 shows a perspective view of a further component of the system for grinding coffee beans of FIG. 1,

FIG. 6 shows a side sectional view of a second embodiment of a system for grinding coffee beans according to the present invention,

FIG. 7 shows an enlargement of a detail of FIG. 6,

FIG. 8 shows a perspective view of a component of the system for grinding coffee beans of FIG. 6,

FIG. 9a shows a perspective view of a first part of the component of FIG. 8,

FIG. 9b shows a perspective view of a second part of the component of FIG. 8,

FIG. 10 shows a perspective view of a further component of the system for grinding coffee beans of FIG. 6.

### DETAILED DESCRIPTION

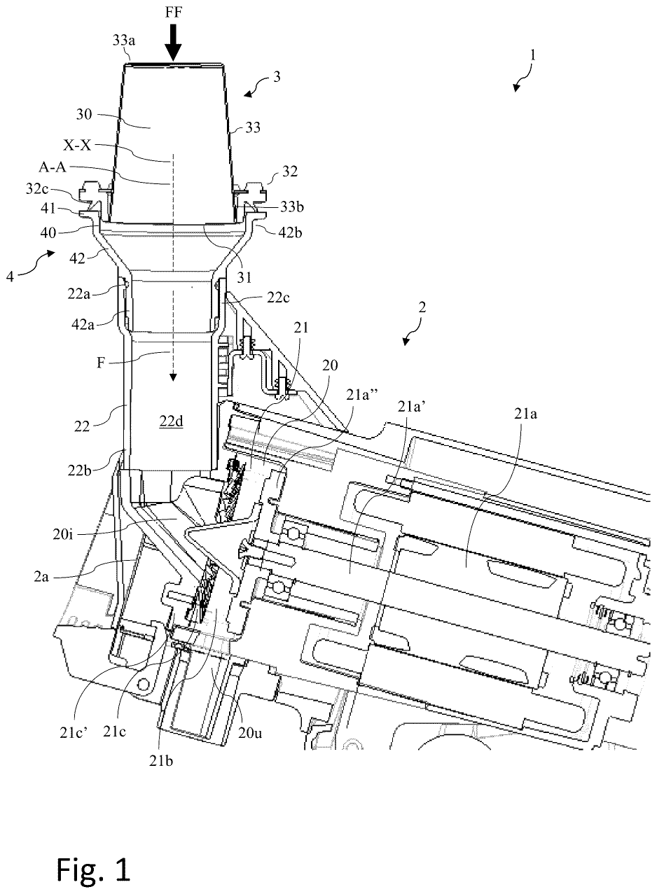

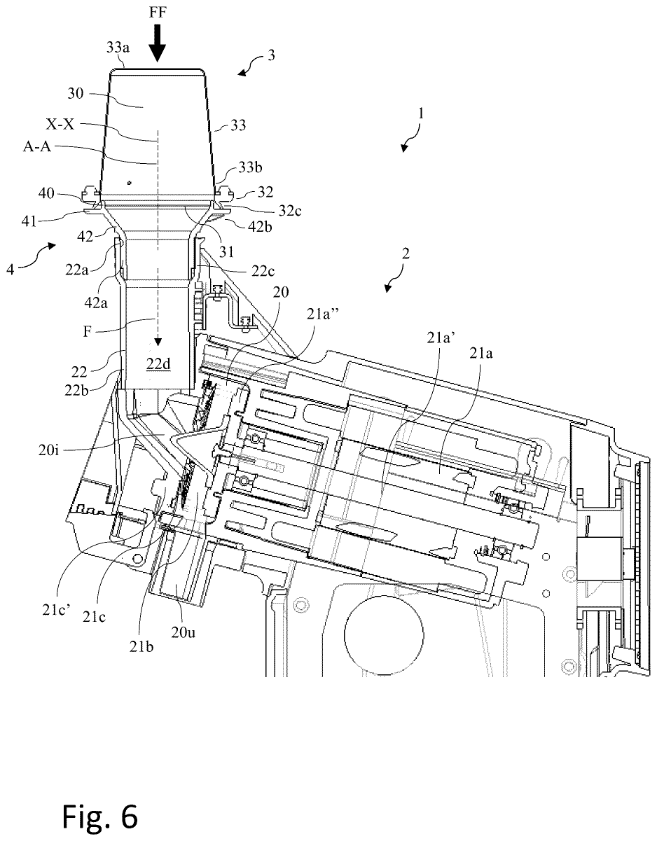

With reference to FIGS. 1 and 6, the present invention has as its object a system 1 for grinding coffee beans.

Although in the following, reference will always be made to coffee beans, it is good to specify that the system object of the present invention is also employable for grinding any other food product that is initially in the form of grains, beans or the like and that needs to be reduced in granulometry to obtain, for example, a ground product in powder form.

The system 1 comprises a coffee grinder 2, i.e. a grinder configured to receive coffee beans at an input and to deliver ground coffee (e.g. coffee powder) at an output, usable for the production of hot coffee-flavoured beverages.

The coffee grinder 2 is provided with a grinding chamber 20 and grinding members 21 disposed in the latter. In use, the grinding members 21 are configured to grind the coffee beans to reduce their granulometry.

In the embodiment shown in FIGS. 1 and 6, the grinding members 21 comprise a motor 21a and a pair of grinding wheels 21b, 21c configured to be set in reciprocal motion by the motor 21a to grind the coffee beans.

In detail, according to one aspect, the pair of grinding wheels 21b comprises a rotating grinding wheel 21b operable in rotation by the motor 21a to which it is kinematically connected-for example, by means of a motor shaft 21a′ and a rotating grinding wheel holder 21a″—and a fixed grinding wheel 21c fixed to the frame 2a of the coffee grinder 2—for example, by means of a fixed grinding wheel holder 21c′.

The operation of the grinding members 21 is controllable by the barista by means of interface elements (not shown in the figure), for example a display, connected to an electronic board placed in signal communication with the grinding members 21.

As shown in FIGS. 1 and 6, the grinding chamber 20 has an inlet 20i through which coffee beans are fed and an outlet 20u through which ground coffee is dispensed.

The coffee grinder 2 further comprises a supply duct 22 placed in communication with the grinding chamber 20 through the inlet 20i and provided with a supply opening 22a.

Said supply duct 22 is configured to convey the coffee beans fed by the barista to the coffee grinder 2 through the supply opening 22a into the grinding chamber 20, where the grinding members 21 grind them to transform them into ground coffee in accordance with what has been described above.

According to one aspect, the supply duct 22 has a predominantly cylindrical development and extends between a first end portion 22b mounted on the fixed grinding wheel holder 21c′ or on the frame 2a and fluid-dynamically connected with the grinding chamber 21, and a second end portion 22c, opposite the first end portion 22b, identifying the supply opening 22a.

Preferably, the second end portion 22c is arranged above the first end portion 22b so that the coffee beans introduced into the supply opening 22a reach the grinding chamber 21 by effect of the force of gravity.

The system 1 object of the present invention further comprises a container 3 (or doser) defining a cavity 30 adapted to contain a dose of coffee beans to be supplied into the supply duct 22 of the coffee grinder 2, and a loading and unloading opening 31 placed in communication with the cavity 30. The loading and unloading opening 31 allows coffee beans to be loaded into the cavity 30 and coffee beans to be unloaded from the cavity 30 into the supply opening 22a.

In use, after having weighed the dose of coffee beans, the barista places it in the cavity of the container 3 so as to be able to transport it towards the coffee grinder 2, where it will be poured into the supply opening 22a.

It should be specified that the container 3 is a component of the system 1 distinct from the coffee grinder 2 which allows performing the operations of transporting and supplying the dose of coffee to be ground. The container 3 is therefore not identifiable with the hoppers with which some coffee grinders known in the state of the art are equipped, since these, besides being components of the respective coffee grinders, are not employable for transporting the coffee beans but simply collect them above the supply duct while awaiting their grinding.

According to one aspect, the cavity 30 of the container 3 is configured to receive the dose of coffee beans associated with a single serving of a coffee-flavoured beverage, i.e. it is the dose of coffee necessary to satisfy a single order from a consumer (e.g. espresso coffee, americano, etc.) or multiple identical orders to be satisfied simultaneously.

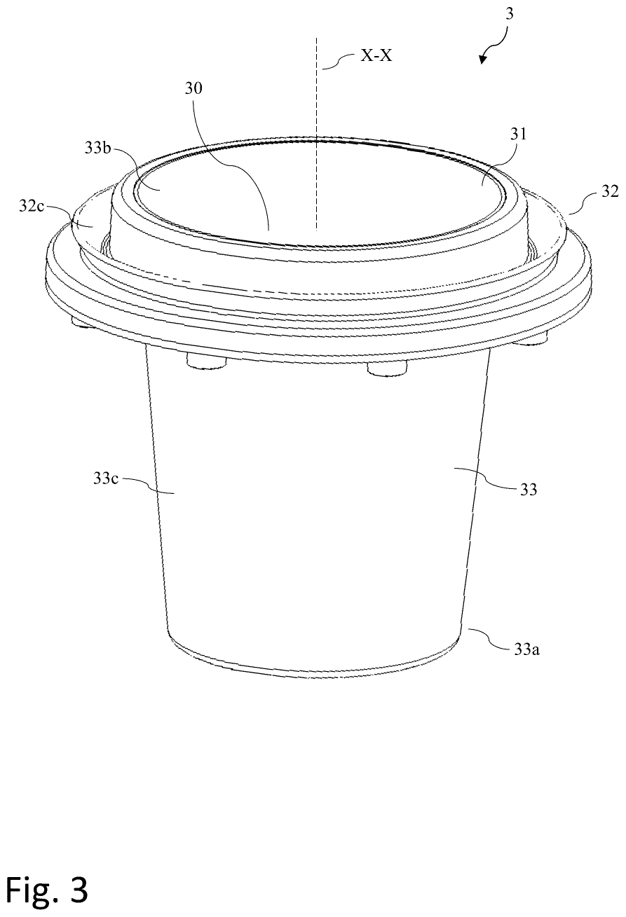

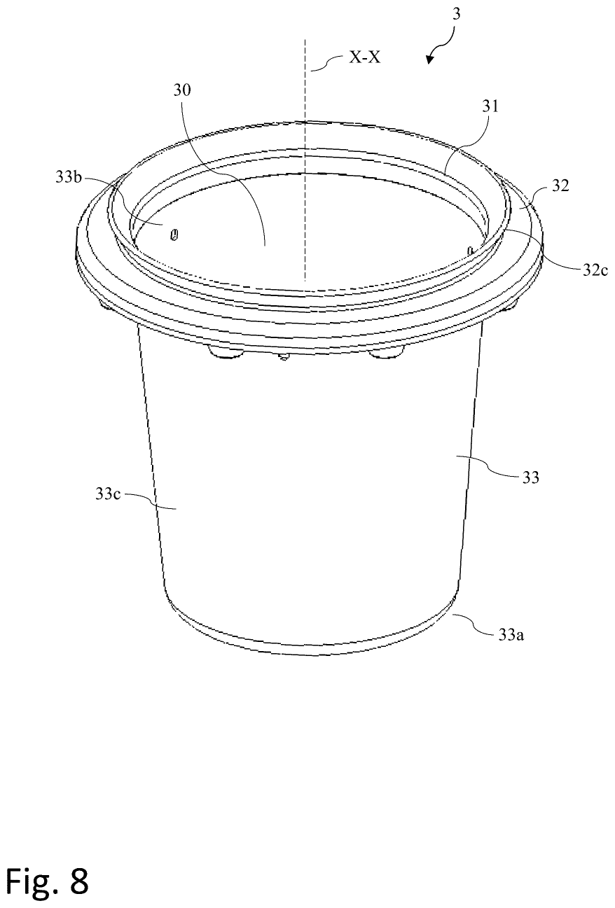

In the embodiments shown in FIGS. 3 and 8, the container 3 has a substantially cup-shaped or beaker-shaped conformation.

In detail, according to one aspect, the container 3 comprises a main body 33 extending between a closed bottom portion 33a and an open head portion 33b identifying the loading and unloading opening 31.

Preferably, the main body 33 defines the cavity 30 which extends between its bottom portion 33a and its head portion 33b. The cavity 30 is therefore preferably delimited by opposite parts by the bottom portion 33a and the head portion 33b of the main body 33. Furthermore, preferably, the main body 33 of the container 3 also has a lateral part 33c extending between the bottom portion 33a and the head portion 33b, laterally delimiting the cavity 30.

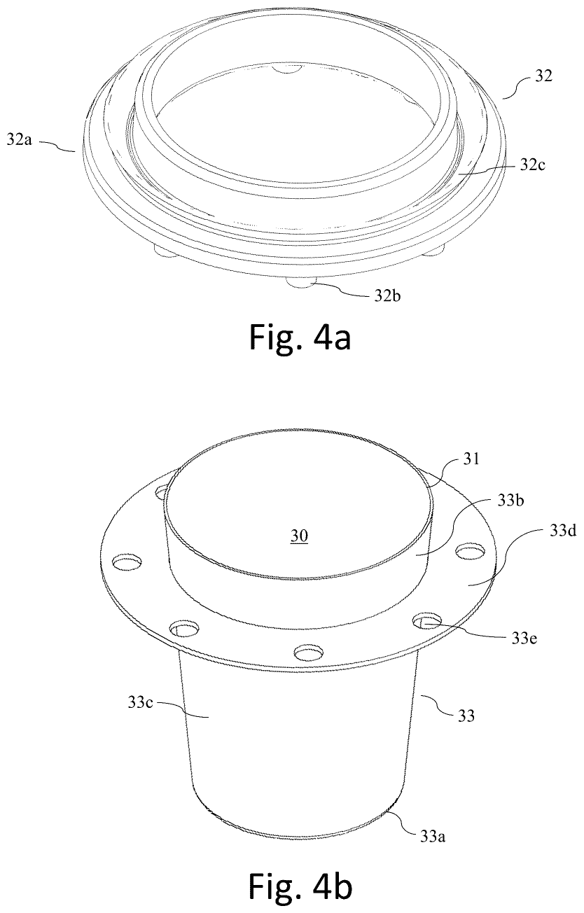

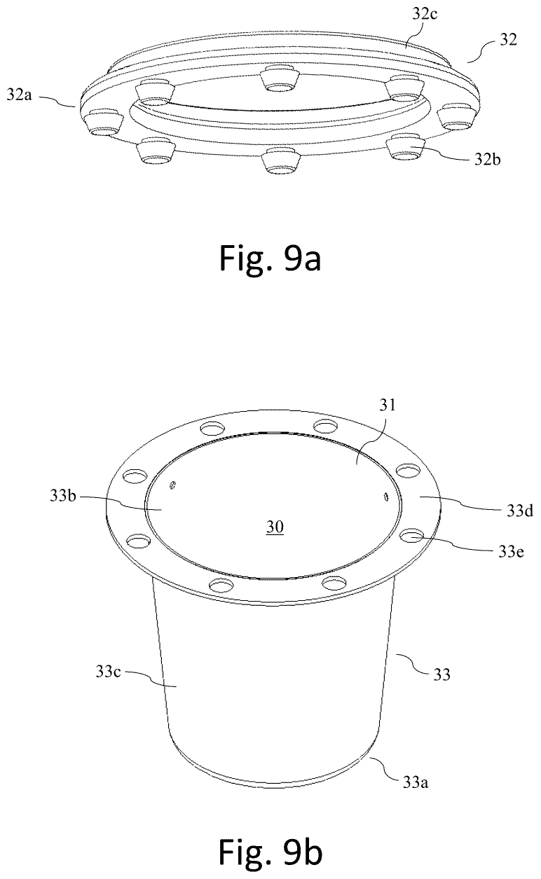

In the embodiments shown in FIGS. 4b and 9b, the main body 33 has a cup-shaped or beaker-shaped conformation, i.e. the lateral wall 30c projects from the bottom portion 33a to which it is connected.

In use, when the head portion 33b is arranged above the bottom portion 33a, the container 3 is configured to be filled with the dose of coffee beans to be ground and moved towards the coffee grinder 2, in particular in proximity to the supply opening 22a of the supply duct 22. The operation of supplying the dose of coffee beans into the grinding chamber 21 is therefore conducted by gradually raising the bottom portion 33a of the container 3 above the head portion 33b, so that by effect of the force of gravity the content of the cavity 30 falls into the supply opening 22a of the supply duct 22.

Preferably, as will emerge more clearly in the following, at the end of the operation of supplying the dose of coffee beans into the supply duct 22, the container 2 is inverted (i.e. with the bottom portion 33a upwards and the head portion 33b downwards) on the supply duct 22 with the loading and unloading opening 31 facing the supply opening 22a.

As shown in FIGS. 1 and 6, the system 1 object of the present invention also comprises coupling members 4 configured to removably couple the container 3 to the supply duct 22 of the coffee grinder 2 so that, when coupled, the cavity 30 of the container 3 is in fluid communication with the grinding chamber 21 through the supply opening 22a and the loading and unloading opening 31.

It is worth noting that, when the coupling members 4 couple the container 3 to the supply duct 22 of the coffee grinder 2, the loading and unloading opening 31 is placed in fluid communication with the supply opening 22a of the supply duct 22.

In use, the container 3 is switchable by the barista between a first operating configuration, in which it is coupled to the supply duct 22 of the coffee grinder 2 through the coupling members 4 so that its cavity 30 is in fluid communication with the grinding chamber 21 of the coffee grinder 2 through the supply duct 22, and a second operating configuration, in which it is uncoupled from the supply duct 22 of the coffee grinder 2.

With reference to the embodiments shown in FIGS. 1 and 6, the container 3 is configured to close (cap) the supply opening 22a when coupled to the supply duct 22 by means of the coupling members 4, i.e. when it is in the first operating configuration. In particular, preferably, in the first operating configuration, the container 3 is mounted on the supply duct 22 by means of the coupling members 4 and caps the supply opening 22a.

Conversely, preferably, in the second operating configuration, the container 3 is disengaged from the coupling members 4 and unmounted from the supply duct 22 and leaves the supply opening 22a free.

According to one aspect shown in FIGS. 1 and 6, the coupling members 4 are configured to removably couple the head portion 33b of the container to the supply duct 22, preferably along what will be defined in the following as the coupling axis A-A. Even more preferably, the container 3 is switchable between the first and second operating configuration by means of a movement to and from the supply opening 22a along the coupling axis A-A.

According to a further aspect, also shown in FIGS. 1 and 6, the coupling members 4 create an airtight connection between the duct 22 and the container 3 so that an air flow can be pumped from the cavity 30 of the container 3 to the internal channel 22d of the duct 22 without significant air leaks (i.e. fluid-dynamic dispersions).

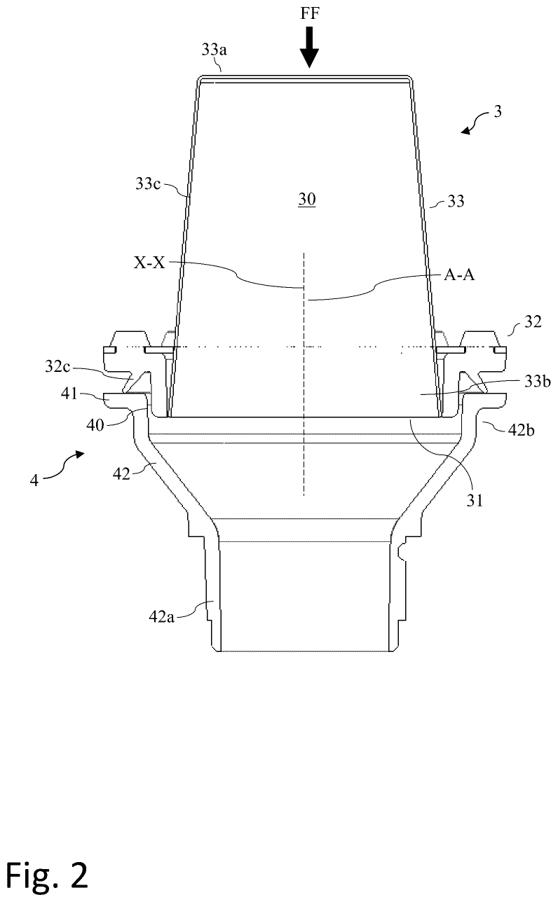

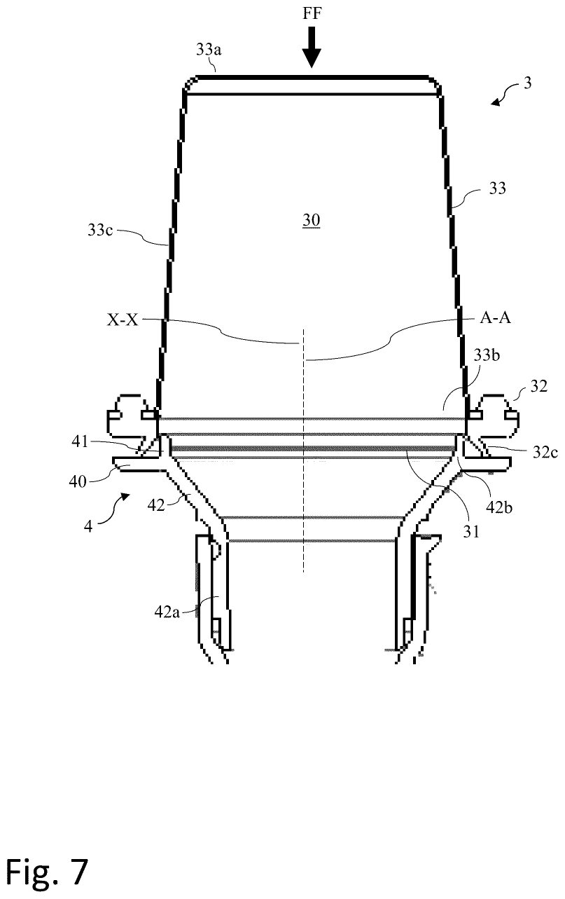

With reference to FIGS. 2 and 7, the container 3 comprises pumping members 32 made of elastomeric material, i.e. of a material that can be elastically deformed by the application of a mechanical stress and which is configured to return to the original configuration once the mechanical stress is removed. In other words, the elastomeric material is a material configured to be elastically deformed in a reversible manner.

In use, when the container 3 is coupled to the supply duct 22 by means of the coupling members 4, the elastic deformation of the pumping members 32 generates an air flow F directed from the cavity 30 of the container 3 to the grinding chamber 21 which allows the removal of the residues of ground coffee accumulated in the latter. In other words, by elastically deforming the pumping members 32, preferably in a cyclical manner, it is possible to clean the grinding chamber 21 of the coffee residues from the previous grinding, preventing them from accidentally entering the subsequent ground product and affecting its quality.

It should be specified that the air flow F passes through the grinding chamber 21 preferably from the inlet 20i to the outlet 20u.

In the embodiments shown in FIGS. 3 and 8, the pumping members 32 are mounted on the head portion 33b of the container 3 and are elastically deformable along a pumping direction X-X oriented transversely to the loading and unloading opening 31. In this embodiment, the deformation of the pumping members 32 along the pumping direction X-X causes the relative motion of the container 3 with respect to the supply duct 22 which leads to the formation of the air flow F.

Preferably, still with reference to the embodiments shown in FIGS. 3 and 8, in use, the barista acts on the container 3 coupled to the supply duct 22 by means of the coupling members 4 by pushing the container 3 towards the supply duct 22, i.e. by moving the head portion 33b of the container 3 towards the supply opening 22a of the duct. By doing so, the barista causes the compression of the pumping members 32 which, by elastically deforming, cause the bottom portion 33a of the container 3 to approach the supply opening 22 and thus the formation of said air flow F.

With reference to FIGS. 1 and 6, it is worth noting that, when the container 3 is coupled to the supply duct 22 by means of the coupling members 4 (first operating configuration), the barista can easily cause the compression of the pumping members 32 by exerting a pushing action FF on the bottom portion 33a of the container 3. When this pushing action FF ceases, the pumping members 32 will return to their undeformed condition causing the bottom portion 33a of the container 3 to move away from the supply duct 22. At this point, should the barista wish to further clean the grinding chamber 20 of the coffee grinder, he can again exert the pushing action FF and then release it as many times as he deems appropriate, thus generating a succession of air flows F.

According to an alternative embodiment, the pumping members 32 are made on the main body 33 of the container 3. For example, the main body 33 may have a deformable annular section made of elastomeric material interposed between the head portion 33b and the bottom portion 33a, or even be made entirely of elastomeric material. It is worth noting that, in these alternative embodiments, the deformation of the pumping members 32 involves a geometric variation of the cavity 30; therefore, in use, when the barista acts on the main body 33 to deform the pumping members 32, he induces a variation in the geometry of the cavity 30 (e.g. volumetric contraction) which pushes the air out of the latter, generating said air flow F.

Preferably, the pumping members 32 comprise a pumping element 32a made of elastomeric material which has, for example, a bellows-like conformation that is elastically collapsible along the pumping direction X-X.

In the embodiment shown in FIGS. 3 and 7, said pumping element 32a has an annular conformation and is mounted, preferably in a removable manner, on the head portion 33b of the main body 33 of the container 3, surrounding the loading and unloading opening 31.

In alternative embodiments not shown in the accompanying figures, the pumping element 32a can be an intermediate annular section of the main body which, by elastically deforming, causes the contraction/expansion of the volume of the cavity 30. Various elastomeric materials are employable to make the pumping members 32 and, where present, the pumping element 32a. Among these elastomeric materials is, for example, rubber.

Preferably, the elastomeric material with which the pumping members 32 are made is non-toxic for humans and, in particular, falls among those employable in contact with food products according to the reference regulations.

In the embodiments shown in FIGS. 3 and 8, the pumping members 32 surround the loading and unloading opening 31 so as to be interposed between the head portion 33b and the supply duct 22 when the container 3 is coupled to the supply duct 22 by means of the coupling members 4 (i.e. it is in the first operating configuration).

In particular, according to one aspect, the pumping members 32 are deformable transversely to a main axis of the loading and unloading opening 31 which, preferably, extends along the pumping direction X-X.

According to one aspect, the pumping members 32 are mounted in a removable manner on the head portion 33b, preferably along the pumping direction X-X. Advantageously, this allows the replacement of the pumping members 32 should they be worn or should it be necessary to use pumping members 32 with a greater pumping capacity (i.e. capable of being subjected to greater elastic deformations).

In the embodiments shown in FIGS. 4a, 4b, 9a, and 9b, the main body 33 of the container 3 is provided with an anchoring wall 33d which extends transversely to the axis of the loading and unloading opening 31 and to which the pumping members 32 are reversibly couplable, for example, by means of a pin connection.

In detail, still with reference to the embodiments shown in FIGS. 4a, 4b, 9a, and 9b, the anchoring wall 33d has a plurality of locking openings 33e arranged around the loading and unloading opening 31 and in which respective locking pins 32b of the pumping members 32 are reversibly lockable (e.g. by interference).

According to one embodiment, the pumping members 32 comprise a wall 32c that is elastically deformable along the pumping direction X-X and abutable against the coupling members 4.

Preferably, the wall 32c surrounds the loading and unloading opening 31.

According to an aspect shown in FIGS. 1 and 6, the coupling members 4 comprise a connection duct 42 configured to fluid-dynamically connect the supply opening 22a of the supply duct 22 with the loading and unloading opening 31 of the container 3, when the latter is coupled to the supply duct 22 by means of the coupling members 4 (i.e. it is in the first operating configuration).

In detail, the connection duct 42 preferably extends between a first end 42a removably mountable on the supply duct 22—preferably, at its second end portion 22c—and a second end 42b, opposite the first end 42a, removably couplable with the container 3. In an alternative embodiment not shown in the accompanying figures, the connection duct 42 is made in one piece with the supply duct 22 of the coffee grinder 2. That is to say that, in this alternative embodiment, the connection duct 42 and the supply duct 22 are a single piece.

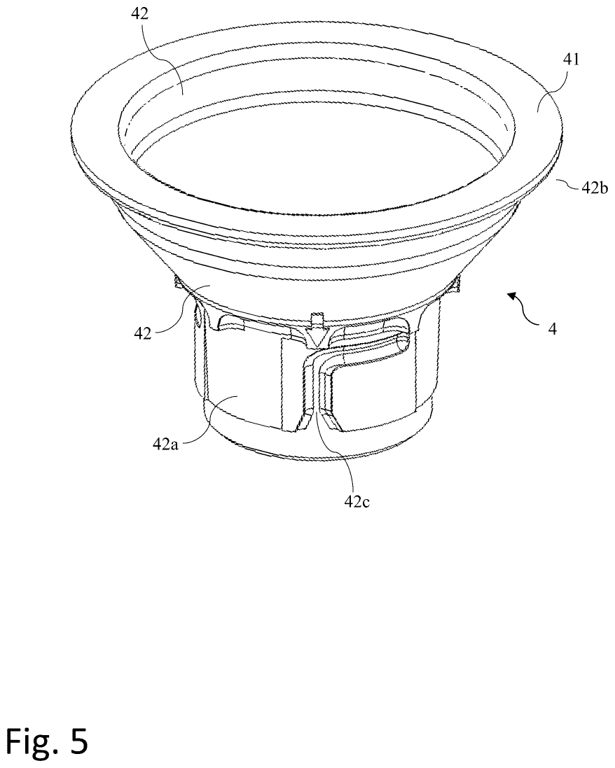

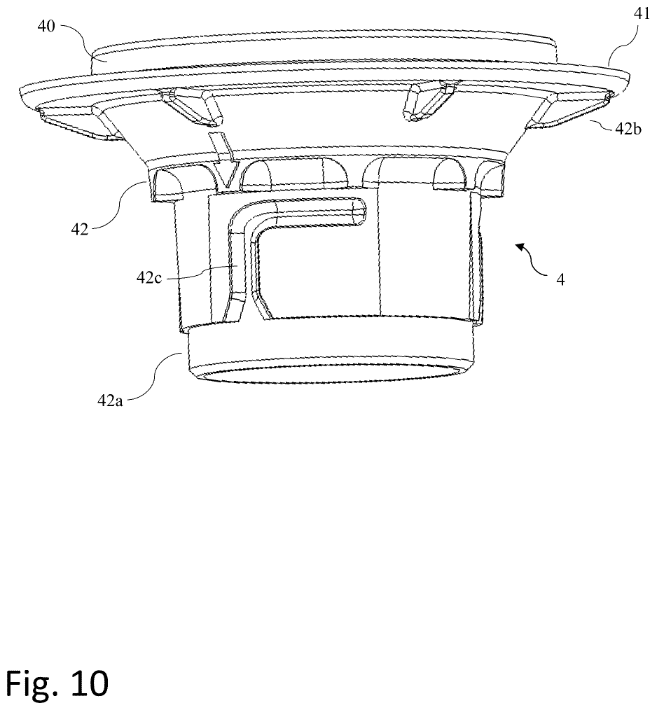

FIGS. 5 and 10 show two different embodiments of the connection duct 42, respectively configured to engage the containers 3 shown in FIGS. 3 and 8 to the supply duct 22.

Both embodiments of the connection duct 42 shown in FIGS. 5 and 10 have a tapered conformation (e.g. frustoconical) from the second end 42b to the first end 42a.

Both embodiments of the connection duct 42 shown in FIGS. 5 and 10, at their second end 42b, have guide members 42c configured to achieve a removable bayonet coupling with respective lugs (not shown) formed on the supply duct 22, in particular at its second end portion 22c.

In alternative embodiments to those shown in FIGS. 5 and 10, the second end 42b of the connection duct 42 is connected by interference to the supply duct 22, in particular to its second end portion 22c.

According to one aspect, the coupling members 4 define a shoulder 40 extending around a coupling axis A-A and configured to engage with the container 3 so as to retain it mounted on the supply duct 22 transversely to the coupling axis A-A and allow its movement to and from the supply duct 22 along the coupling axis A-A to allow its switching between the first and the second operating configuration.

In other words, the shoulder 40 is configured to centre the container 3 on the supply duct 22 so that the loading and unloading opening 31 of the container 3 faces the supply opening 22a. In detail, preferably, the shoulder 40 is configured to centre (e.g. make coaxial) the loading and unloading opening 31 of the container 3 with respect to the supply opening 22a of the supply duct 22.

Preferably, the shoulder 40 creates an annular wall 40a configured to abut and retain the head portion 33b of the container 3 transversely to the coupling axis A-A.

For example, in the embodiment of FIG. 2, the shoulder 40 is configured to come into contact with the head portion 33b of the container 3, externally surrounding the loading and unloading opening 31. Conversely, in the embodiment of FIG. 7, the shoulder 40 is configured to abut the head portion 33b of the container 3, internally surrounding the loading and unloading opening 31.

Preferably, the shoulder 40 is defined by the connection duct 42. In the embodiments shown in FIGS. 5 and 10, the shoulder 40 is defined by the second end 42b of the connection duct 42.

According to one aspect, the pumping direction X-X extends along the coupling axis A-A when the container 3 is in the first operating configuration.

More preferably, the pumping direction X-X and/or the coupling axis A-A extend parallel to the direction of action of the force of gravity (i.e. vertical direction).

According to a further aspect, the coupling members 4 define a support wall 41 configured to receive in abutment the container 3, preferably its head portion 33b, and support it along the coupling axis A-A.

According to an aspect shown in FIGS. 2 and 7, when the container is in the first operating configuration, the bottom portion 33a is preferably arranged above the head portion 33b which is supported by the support wall 41 along the pumping direction X-X. By doing so, the support wall offers a reaction constraint to the pushing action FF exerted by the barista to generate the air flow F aimed at cleaning the grinding chamber 20.

According to a further aspect shown in FIGS. 2 and 7, when the container is in the first operating configuration, the pumping members 32, preferably the pumping element 32a, abut against the support wall 41 along the coupling axis A-A.

The support wall 41 preferably extends transversely to the coupling axis A-A, projecting from the shoulder 40.

Preferably, the support wall 41 is defined by the connection duct 42. In the embodiments shown in FIGS. 5 and 10, the support wall 41 is defined by the second end 42b of the connection duct 42.

As shown in FIGS. 1 and 6, when the connection duct 42 is mounted on the supply duct 22, the shoulder 40 and/or the support wall 41 extend around the supply opening 22a which, preferably, has the coupling direction A-A as its axis.

The present invention also has as its object a kit 10 for a coffee grinder 2 comprising the container 3 and the coupling members 4 described above.

FIGS. 1 and 6 show the kit 10 with the coupling members 4 mounted on the supply duct 22 of the coffee grinder 2 and the container 3 in the first operating configuration so that, by elastically deforming the pumping members 32, it is possible to generate the air flow F directed from the cavity 30 to the grinding chamber 20.

The present invention also relates to a method for grinding coffee beans by means of the system 1 described above.

This method provides first of all to at least partially fill the cavity 30 of the container 3 with a dose of coffee beans to be ground (step A).

To ascertain the correctness of the dose of coffee beans placed in the cavity 30 of the container 3, the barista can previously weigh it using a suitable scale.

It should be specified that in step A the container 3 is uncoupled from the coupling members 4, i.e. it is in the second operating configuration.

Once the cavity 30 of the container 3 is filled, the method provides for coupling the container 3 to the supply duct 22 by means of the coupling members 4 so as to supply the dose of coffee beans into the grinding chamber 20 in accordance with what has been described above (step B).

In step B, the container 3 is therefore switched from the second to the first operating configuration. In detail, to do this, the barista can move the container 3 filled with the dose of coffee beans towards the supply duct 22 to then pour itscontent into the supply opening 22a by turning the container 3 upside down and engaging its head portion 33b with the coupling members 4.

The method also provides for operating the grinding members 21 of the coffee grinder 2 to grind the coffee beans supplied into the supply duct 22 and transform them into ground coffee (step C).

The operation of the grinding members 21 can be performed both upstream and downstream of step B.

When the grinding of the supplied dose of coffee beans is ended or during the grinding step, the method provides for acting on the container 3 coupled to the supply duct 22 by means of the coupling members 4 to elastically deform the pumping members 32 and generate the air flow F described above (step D). This operation can be performed, for example, by the barista by exerting the pushing action FF on the bottom portion 33a of the container as indicated in FIGS. 1 and 6.

Obviously, a person skilled in the art may make numerous equivalent modifications to the variants described above, without thereby departing from the scope of protection defined by the appended claims.

1. A system for grinding coffee beans, comprising:
a coffee grinder comprising:
a grinding chamber,
grinding members arranged in the grinding chamber and configured to grind coffee beans and obtain ground coffee,
a supply duct placed in communication with the grinding chamber and having a supply opening, the supply duct being configured to convey coffee beans from the supply opening to the grinding chamber,
a container comprising:
a cavity adapted to contain a dose of coffee beans to be supplied into the supply duct through the supply opening,
a loading and unloading opening, placed in communication with the cavity, configured to allow coffee beans to be loaded into the cavity and coffee beans to be unloaded from the cavity into the supply opening,
wherein the system comprises coupling members configured to removably couple the container to the supply duct of the coffee grinder so that, when coupled, the cavity of the container is in fluid communication with the grinding chamber through the supply opening and the loading and unloading opening,
and wherein the container comprises pumping members made of elastomeric material and configured to be elastically deformed, the elastic deformation of said pumping members generating an air flow directed from the cavity of the container to the grinding chamber when the container is coupled to the supply duct by means of the coupling members.

2. The system according to claim 1, wherein the container is configured to close the supply opening when coupled to the supply duct by means of the coupling members.

3. The system according to claim 1, wherein:
the container comprises a main body extending between a closed bottom portion, and an open head portion identifying the loading and unloading opening,
the coupling members are configured to removably couple the head portion of the container to the supply duct.

4. The system according to claim 3, wherein the pumping members are mounted on the head portion and are elastically deformable along a pumping direction oriented transversely to the loading and unloading opening.

5. The system according to claim 4, wherein the pumping members surround the loading and unloading opening so as to be interposed between the head portion and the supply duct when the container is coupled to the supply duct by means of the coupling members.

6. The system according to claim 1, wherein the coupling members define a shoulder extending around a coupling axis and configured to engage with the container to:
retain the container mounted on the supply duct transversely to the coupling axis,
allow the movement of the container with respect to the supply duct along the coupling axis.

7. The system according to claim 6, wherein the coupling members define a support wall configured to receive abuttingly and support the container along the coupling axis, said shoulder projecting from the support wall transversely to the coupling axis.

8. The system according to claim 1, wherein the coupling members comprise a connection duct extending between a first end removably mountable on the supply duct and a second end removably couplable with the container, said connection duct being configured to fluid-dynamically connect the supply opening of the supply duct with the loading and unloading opening of the container.

9. The system according to claim 1, wherein the coupling members make an airtight connection between the container and the duct.

10. A method for grinding coffee beans by means of a system for grinding coffee beans, the system comprising:
a coffee grinder comprising:
a grinding chamber,
grinding members arranged in the grinding chamber and configured to grind coffee beans and obtain ground coffee,
a supply duct placed in communication with the grinding chamber and having a supply opening, the supply duct being configured to convey coffee beans from the supply opening to the grinding chamber,
a container comprising:
a cavity adapted to contain a dose of coffee beans to be supplied into the supply duct through the supply opening,
a loading and unloading opening, placed in communication with the cavity, configured to allow coffee beans to be loaded into the cavity and coffee beans to be unloaded from the cavity into the supply opening,
wherein the system comprises coupling members configured to removably couple the container to the supply duct of the coffee grinder so that, when coupled, the cavity of the container is in fluid communication with the grinding chamber through the supply opening and the loading and unloading opening,
and wherein the container comprises pumping members made of elastomeric material and configured to be elastically deformed, the elastic deformation of said pumping members generating an air flow directed from the cavity of the container to the grinding chamber when the container is coupled to the supply duct by means of the coupling members,
the method comprising the steps of:
at least partially filling the cavity of the container with a dose of coffee beans,
coupling the container to the supply duct by means of the coupling members so as to pour into the supply opening of the supply duct the dose of coffee beans contained in the cavity of the container,
operating the grinding members of the coffee grinder to grind the dose of coffee beans supplied into the supply duct,
when the grinding of the supplied dose of coffee beans is ended or during the grinding step, acting on the container coupled to the supply duct to elastically deform the pumping members and generate an air flow directed from the cavity of the container and to the grinding chamber.

11. A kit for a coffee grinder, comprising:
a container having a cavity adapted to contain a dose of coffee beans to be ground and a loading and unloading opening placed in communication with the cavity to allow coffee beans to be loaded into the cavity and to allow coffee beans to be unloaded from the cavity,
wherein the kit comprises coupling members configured to removably couple the container to a supply duct of the coffee grinder,
and wherein the container comprises pumping members made of elastomeric material and configured to be elastically deformed, the elastic deformation of said pumping members generating an air flow directed from the cavity of the container to a grinding chamber of the coffee grinder placed in fluid communication with the supply duct.
